(19) United States
(12) Patent Application Publication
(10) Pub. No.: US 2024/0319452 A1
(43) Pub. Date: Sep. 26, 2024

(54) OPTICAL RECEPTACLE AND OPTICAL MODULE

(71) Applicant: Enplas Corporation, Saitama (JP)

(72) Inventors: Hiroyoshi KANI, Saitama (JP); Honoka NARA, Saitama (JP)

(73) Assignee: Enplas Corporation, Saitama (JP)

(21) Appl. No.: 18/269,763

(22) PCT Filed: Dec. 28, 2020
(86) PCT No.: PCT/JP2020/049186

§ 371 Date: Jun. 27, 2023

(51) Int. Cl. G02B 6/42

(52) U.S. Cl. CPC G02B 6/4214

(57) ABSTRACT

An optical receptacle according to the invention has: a first optical surface through which light; and a second optical surface through which light is emitted. When an intersection point of the optical axis of the first optical surface and the first optical surface is defined as an origin, the optical axis of the first optical surface is defined as a Z axis, the axis passing through the origin and perpendicular to the Z axis is defined as an X axis, and the axis perpendicular to the Z axis and the X axis is defined as a Y axis, the first optical surface is configured such that, when collimate light enters through the first optical surface from the inside of the optical receptacle, a second focal point is observed closer to the first optical point as compared with a first focal point.

### TECHNICAL FIELD

The present invention relates to an optical receptacle and an optical module.

### BACKGROUND ART

Conventionally, an optical module including a photoelectric conversion element is used for optical communication that uses an optical transmission member such as an optical fiber or an optical waveguide. When the optical module is for transmission, the optical module includes an optical receptacle for allowing the incidence of light that contains communication information and is emitted from a light emitting element on the end surface of an optical transmission member. On the other hand, when the optical module is for reception, the optical module includes an optical receptacle for allowing light that contains communication information and is emitted from an optical transmission member to enter a light receiving element. Patent Literatures 1 and 2 disclose such an optical receptacle.

### CITATION LIST

### Patent Literature

### PTL 1

Japanese Patent Application Laid-Open No. 2013-24917

### PTL 2

Japanese Patent Application Laid-Open No. 2016-142899

### SUMMARY OF INVENTION

### Technical Problem

In an optical receptacle as disclosed in PTLs 1 and 2, the lens (optical surface) facing the photoelectric conversion element (light emitting element or light receiving element) is typically a circularly symmetrical convex lens surface with a shallow depth of focus.

FIG. 1 illustrates a state when collimated light from the inside of an optical receptacle is incident on the circularly symmetrical convex lens surface with a shallow depth of focus. In the drawing, the origin is defined as the intersection point between the convex lens surface and the optical axis of the convex lens surface, the Z axis is defined as the optical axis of the convex lens surface, the X axis is defined as an axis passing through the origin and perpendicular to the Z axis, and the Y axis is defined as an axis perpendicular to the Z axis and the X axis. The curvature of the convex lens surface on the XZ plane passing through the origin is the same as the curvature of the convex lens surface on the YZ plane passing through the origin. As illustrated in FIG. 1, the light incident on the circularly symmetrical convex lens surface converges to one point (focal point) on the Z axis.

When the convex lens surface is used for the incident surface (optical surface facing a light emitting element) of an optical receptacle of an optical module for transmission, the light emitting element is disposed in a predetermined range (Z tolerance range) in such a way that the position of the focal point in FIG. 1 is at the center of the predetermined range, and the optical coupling efficiency is in an acceptable range. On the other hand, when the convex lens surface is used for the emission surface (optical surface facing a light receiving element) of an optical receptacle of an optical module for reception, the light receiving element is disposed in a predetermined range (Z tolerance range) in such a way that the position of the focal point in FIG. 1 is at the center of the predetermined range, and the optical coupling efficiency is in an acceptable range.

In general, the Z tolerance range of the convex lens surface is narrow; thus, high accuracy is required for positioning the photoelectric conversion element during the assembling of the optical module. In addition, even when the photoelectric conversion element is properly positioned during the assembling of the optical module, the focal position of the convex lens surface may move in the Z-axis direction due to temperature changes during use of the optical module, which may cause the position of the photoelectric conversion element to shift to the outside of the Z tolerance range.

An object of the present invention is to provide an optical receptacle whose optical surface facing a photoelectric conversion element has a wide Z tolerance range and also to provide an optical module including the optical receptacle.

### Solution to Problem

An optical receptacle of the present invention is configured to be disposed between a photoelectric conversion element and an optical transmission member, the optical receptacle being configured to optically couple the photoelectric conversion element with an end surface of the optical transmission member, the optical receptacle including: a first optical surface configured to allow light emitted from the photoelectric conversion element to be incident thereon, or configured to emit, toward the photoelectric conversion element, light emitted from the end surface of the optical transmission member and traveling inside the optical receptacle; and a second optical surface configured to emit the light incident on the first optical surface toward the end surface of the optical transmission member, or configured to allow the light emitted from the end surface of the optical transmission member to be incident thereon, in which
when an origin is defined as an intersection point between the first optical surface and an optical axis of the first optical surface, a Z axis is defined as the optical axis of the first optical surface, an X axis is defined as an axis passing through the origin and perpendicular to the Z axis, and a Y axis is defined as an axis perpendicular to the Z axis and the X axis, the first optical surface is configured in such a way that when collimated light from an inside of the optical receptacle is incident on the first optical surface, a first focal point observed when viewed along a direction of the X axis and a second focal point observed when viewed along a direction of the Y axis are formed, the second focal point being observed closer to the first optical surface than the first focal point is.

An optical module according to the present invention includes a photoelectric conversion element and the optical receptacle according to the present invention.

### Advantageous Effects of Invention

The present invention is capable of providing an optical receptacle whose optical surface facing a photoelectric conversion element has a wide Z tolerance range, and also an optical module including the optical receptacle. Therefore, the present invention is capable of providing an optical module that is easy to assemble and resistant to temperature changes.

### BRIEF DESCRIPTION OF DRAWINGS

FIG. 1 illustrates a state when collimated light is incident on a circularly symmetrical convex lens surface with a shallow depth of focus;

FIGS. 2A and 2B illustrate configurations of an optical module and an optical receptacle according to Embodiment 1;

FIG. 3 illustrates first and second focal points formed by the first optical surface;

FIG. 4A illustrates a simulation setup for the optical module according to Embodiment 1, and FIGS. 4B and 4C illustrate simulation results for the optical module according to Embodiment 1;

FIGS. 5A to 5C illustrate configurations of an optical module and an optical receptacle according to Embodiment 2; and

FIG. 6A illustrates a simulation setup for the optical module according to Embodiment 2, and FIGS. 6B and 6C illustrate simulation results for the optical module according to Embodiment 2.

### DESCRIPTION OF EMBODIMENTS

Hereinafter, embodiments according to the present invention will be described in detail with reference to the accompanying drawings.

### Embodiment 1

### Configuration of Optical Module

Hereinafter, an optical module according to Embodiment 1 of the present invention will be described in detail with reference to the attached drawings.

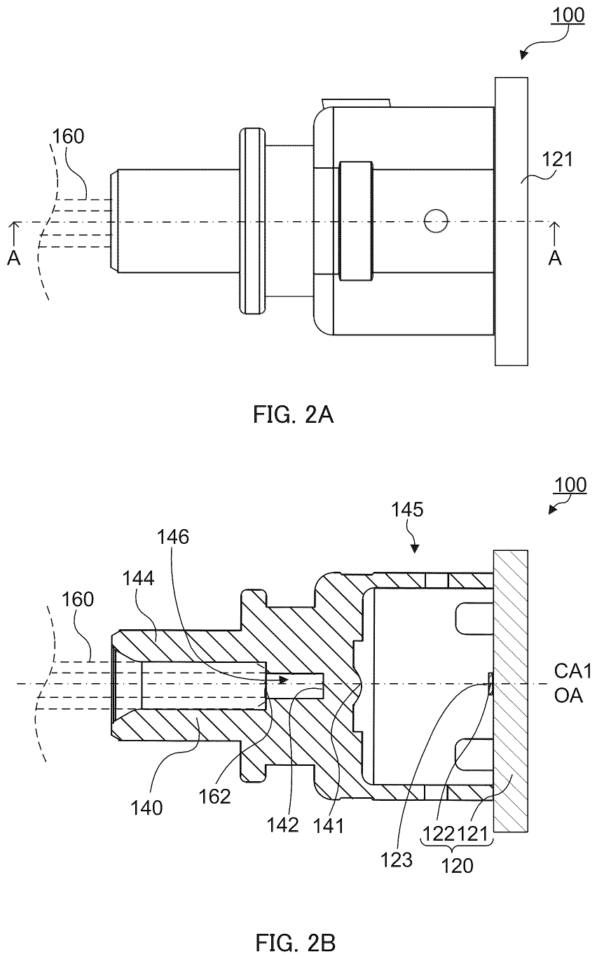

FIGS. 2A and 2B illustrate a configuration of optical module 100 according to Embodiment 1 of the present invention. FIG. 2A is a plan view of optical module 100, and FIG. 2B is a cross-sectional view taken along line A-A of FIG. 2A. In FIGS. 2A and 2B, optical transmission member 160 is indicated by a dashed line.

As illustrated in FIGS. 2A and 2B, optical module 100 includes optical receptacle 140 and substrate-mounted photoelectric conversion device 120 that includes light emitting element 122. In the present embodiment, optical module 100 is an optical module for transmission, and is used with optical receptacle 140 coupled (hereinafter also referred to as connected) with optical transmission member 160.

Photoelectric conversion device 120 includes substrate 121 and light emitting element 122.

Substrate 121 supports light emitting element 122 and is fixed with respect to optical receptacle 140. Substrate 121 is, for example, a glass composite substrate, a glass epoxy substrate, or a flexible substrate. Light emitting element 122 is disposed on substrate 121.

Light emitting element 122 emits light toward optical transmission member 160. Light emitting element 122 is, for example, a vertical cavity surface emitting laser (VCSEL). The number of light emitting elements 122 is not limited, and is selected according to the configuration of optical receptacle 140. In the present embodiment, the number of light emitting elements 122 is one. Light emitting element 122 is disposed in such a way that its light emitting surface 123 is positioned within the Z tolerance range of first optical surface 141 of optical receptacle 140.

Optical receptacle 140 is disposed on substrate 121 of photoelectric conversion device 120. Optical receptacle 140 optically couples light emitting surface 123 of light emitting element 122 with end surface 162 of optical transmission member 160 while being disposed between the photoelectric conversion element (light emitting element 122) and optical transmission member 160. In the present embodiment, optical receptacle 140 optically couples light emitting surface 123 of one light emitting element 122 with end surface 162 of one optical transmission member 160. However, optical receptacle 140 may optically couple light emitting surfaces 123 of a plurality of light emitting elements 122 with end surfaces 162 of a plurality of optical transmission members 160, respectively. The configuration of optical receptacle 140 will be described in detail separately.

The type of optical transmission member 160 is not limited. Examples of optical transmission member 160 include optical fibers and optical waveguides. In the present embodiment, optical transmission member 160 is an optical fiber. The number of light optical transmission members 160 is not limited, and is selected according to the configuration of optical receptacle 140. The number of optical transmission members 160 may be one or more than one. In the present embodiment, the number of optical transmission members 160 is one.

Although the optical module is an optical module for transmission in the above description, the optical module may be an optical module for reception. In the case of an optical module for reception, the photoelectric conversion element is a light receiving element in place of a light emitting element, and light emitted from optical transmission member 160 enters the light receiving element.

### Configuration of Optical Receptacle

Optical receptacle 140 allows light to pass therethrough and includes first optical surface 141 and second optical surface 142. First optical surface 141 allows at least part of the light emitted from light emitting element 122 to enter optical receptacle 140. Second optical surface 142 emits the light, having entered through the first optical surface, toward the end surface of optical transmission member 160. In the present embodiment, the number of first optical surfaces 141 is one and the number of second optical surfaces 142 is also one. In the present embodiment, optical receptacle 140 further includes substrate fixing portion 145 and positioning portion 144 that is configured to position optical transmission member 160. Substrate fixing portion 145 is configured to fix optical receptacle 140 onto substrate 121 while determining the distance between first optical surface 141 and light emitting surface 123 of light emitting element 122 in the direction along the Z axis (optical axis direction of light emitting element 122).

Optical receptacle 140 is formed of a material that allows light having a wavelength used for optical communication to pass therethrough. Examples of such materials include transparent resins such as polyetherimide (PEI) and cyclic olefin resins. Moreover, optical receptacle 140 is produced by, for example, injection molding.

Positioning portion 144 positions end surface 162 of optical transmission member 160 with respect to optical receptacle 140. Positioning portion 144 may have any configuration as long as the positioning portion can exhibit the above function. In the present embodiment, positioning portion 144 has a shape of a cylinder with a bottom. Inserting optical transmission member 160 from the opening of positioning portion 144 allows the end of optical transmission member 160 to be disposed in the hollow portion of positioning portion 144. First recess 146 is disposed at the bottom of positioning portion 144.

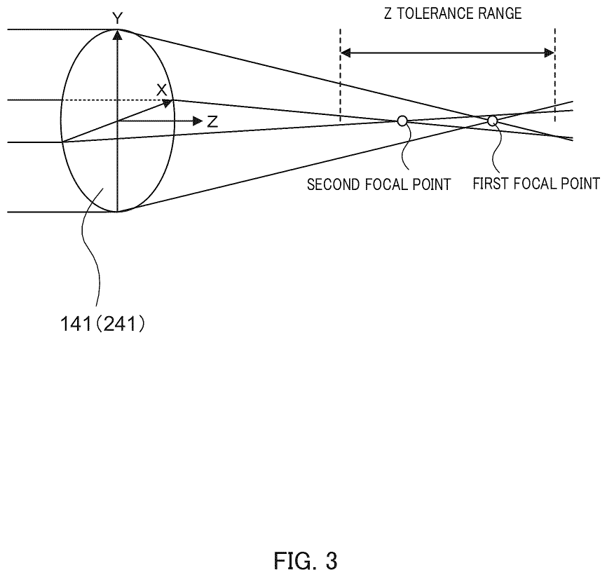

First optical surface 141 is an optical surface that allows light emitted from light emitting element 122 to enter optical receptacle 140. First optical surface 141 is formed on the bottom of substrate fixing portion 145 described below. In the present embodiment, first optical surface 141 is a convex lens surface that is convex toward light emitting element 122. Details of the shape of first optical surface 141 will be described with reference to FIG. 3.

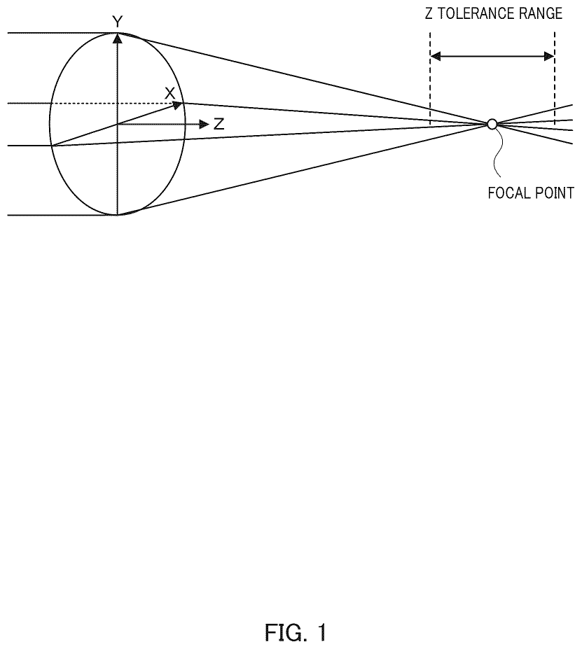

FIG. 3 illustrates a state when collimated light from the inside of optical receptacle 140 is incident on first optical surface 141. In the drawing, the origin is defined as the intersection point between first optical surface 141 and the optical axis of first optical surface 141, the Z axis is defined as the optical axis of first optical surface 141, the X axis is defined as an axis passing through the origin and perpendicular to the Z axis, and the Y axis is defined as an axis perpendicular to the Z axis and the X axis. The curvature of first optical surface 141 on the XZ plane passing through the origin is larger than the curvature of first optical surface 141 on the YZ plane passing through the origin. That is, first optical surface 141 is a convex lens surface in which the curvature on the XZ plane passing through the origin is greater than the curvature on the YZ plane passing through the origin. Therefore, as illustrated in FIG. 3, light incident on first optical surface 141 does not converge to one point (focal point) on the Z axis. Specifically, when collimated light from the inside of optical receptacle 140 is incident on first optical surface 141, a first focal point observed when viewed along a direction of the X axis and a second focal point observed when viewed along a direction of the Y axis are formed, and the second focal point is observed closer to the first optical surface than the first focal point is. The first focal point is formed due to the curvature of first optical surface 141 along the Y-axis direction, and the second focal point is formed due to the curvature of first optical surface 141 along the X-axis direction. That is, first optical surface 141 is configured in such a way that when collimated light from the inside of optical receptacle 140 is incident on first optical surface 141, a first focal point observed when viewed along a direction of the X axis and a second focal point observed when viewed along a direction of the Y axis are formed, and the second focal point is observed closer to the first optical surface than the first focal point is. By configuring first optical surface 141 in this manner, the depth of focus of first optical surface 141 can be increased and the Z tolerance range can be widened (compare FIG. 3 to FIG. 1).

In the present embodiment, first optical surface 141 is symmetrical with respect to the XZ plane and also symmetrical with respect to the YZ plane. Therefore, first optical surface 141 is not circularly symmetrical, but is two-fold symmetrical.

Although the example in which first optical surface 141 is a convex lens surface has been described above, first optical surface 141 is not limited thereto. First optical surface 141 may have any configuration as long as the first optical surface can form a first focal point and a second focal point, and may be, for example, a diffractive lens.

In the present embodiment, the distance between the first focal point and the second focal point is preferably 100 μm or more and 180 μm or less from the viewpoints of optical coupling efficiency and correct signal transmission. Details of this will be described below.

The size of first optical surface 141 is not limited but is preferably equal to or larger than the size of light emitting surface 123 of light emitting element 122. Central axis CA1 of first optical surface 141 is preferably perpendicular to light emitting surface 123 of light emitting element 122. Central axis CA1 of first optical surface 141 preferably coincides with optical axis OA of light emitted from light emitting surface 123 of light emitting element 122.

Disposing first optical surface 141 on the bottom of substrate fixing portion 145 described below can separate light emitting surface 123 of light emitting element 122 from first optical surface 141, thereby preventing damage to light emitting surface 123 of light emitting element 122 and first optical surface 141. Light emitting surface 123 of light emitting element 122 is disposed so as to be positioned within the Z tolerance range of first optical surface 141, preferably positioned near the center of the Z tolerance range.

The bottom of positioning portion 144 contacts the cladding of optical transmission member 160. Thereby, end surface 162 of optical transmission member 160 can receive light emitted from light emitting element 122.

Second optical surface 142 is an optical surface that emits light, traveling from first optical surface 141, toward end surface 162 of optical transmission member 160. In the present embodiment, second optical surface 142 is disposed to face away from first optical surface 141 and face end surface 162 of optical transmission member 160. Second optical surface 142 may have any shape. In the present embodiment, second optical surface 142 is a flat surface.

Substrate fixing portion 145 fixes optical receptacle 140 with respect to substrate 121. Substrate fixing portion 145 may have any configuration as long as the substrate fixing portion can exhibit the above function. In the present embodiment, substrate fixing portion 145 has a shape of a cylinder with a bottom.

Although the optical receptacle is an optical receptacle for transmission in the above description, the optical receptacle may be an optical receptacle for reception. In the case of an optical receptacle for reception, second optical surface 142 allows light from an optical transmission member to enter the optical receptacle, and first optical surface 141 emits the light toward light receiving element.

### Simulation

Hereinafter, in optical module 100 according to Embodiment 1, the relationships between the following will be described: the distance between two focal point (herein also referred to as “interfocal distance”), i.e., between the first focal point and the second focal point; the positional deviation of light emitting element 122 in the direction along the Z axis; and the optical coupling efficiency between light emitting element 122 and optical transmission member 160.

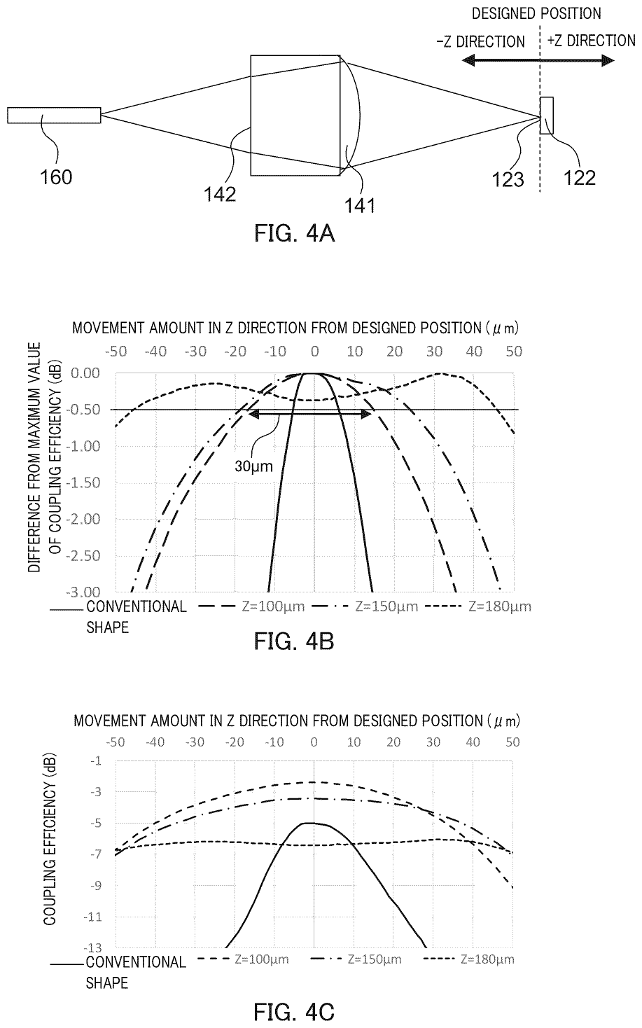

FIG. 4A schematically illustrates a state when light is emitted from light emitting element 122, is incident on first optical surface 141, and reaches optical transmission member 160. It should be noted that FIG. 4A is for illustration purposes and is not drawn to scale.

FIG. 4B illustrates the relationships between the following: the distance between the first focal point and the second focal point (interfocal distance); the amount of movement of light emitting element 122 from a designed position; and the change in the optical coupling efficiency between light emitting element 122 and optical transmission member 160. As illustrated in FIG. 4A, the amount of movement (herein also referred to as “movement amount”) from the designed position was given a negative value when the distance between light emitting element 122 and first optical surface 141 decreases, and a positive value when the distance increases.

FIG. 4B is a graph showing the changes in the optical coupling efficiency when the distance between light emitting element 122 and first optical surface 141 is changed as illustrated in FIG. 4A for the cases where the interfocal distances between the first focal point and the second focal point are as follows: 0 μm (prior art with one focal point), 100 μm (Z=100 μm), 150 μm (Z=150 μm), and 180 μm (Z=180 μm). In this graph, 0 dB is used as the optical coupling efficiency at the maximum value for each interfocal distance. In addition, the distance between light emitting surface 123 of light emitting element 122 and first optical surface 141 is set to 1.56 mm at the designed position.

As can be seen from FIG. 4B, the shorter the interfocal distance is, the more vulnerable to the change in the distance between light emitting element 122 and first optical surface 141. The change in the distance between light emitting element 122 and first optical surface 141 increases the difference from the maximum value of the coupling efficiency. That is, the shorter the interfocal distance, the narrower the Z tolerance range.

It is generally preferred that an optical receptacle satisfy the following specifications. That is, even when the temperature changes from 0° C. to 70° C. to change the distance between light emitting element 122 and first optical surface 141 by 30 μm at maximum, the width of the change in the coupling efficiency is preferably limited to −0.5 dB.

In FIG. 4B, the conventional optical receptacle with an interfocal distance of 0 μm cannot limit the difference from the maximum value of the coupling efficiency to −0.5 dB, in the range where the movement amount is 30 μm (the curve is not symmetrical in the horizontal direction, but in the range of approximately +15 μm from the point of 0 μm), thus does not satisfy the above specifications. On the other hand, all the optical receptacles 140 according to the present embodiment with the interfocal distances of 100 μm, 150 μm, and 180 μm can limit the difference from the maximum value of the coupling efficiency to −0.5 dB in the above range, thus satisfy the above specifications.

The above results are shown numerically in Table 1 below. Specifically, Table 1 shows the following: the difference between the distance between the first focal point and the second focal point (interfocal distance); and the Z tolerance range (the movable distance of light emitting element 122 in the direction along the Z axis where the difference from the maximum value of the coupling efficiency falls within the range of −0.5 dB).

TABLE 1

| | 0 μm | | | |
|---|---|---|---|---|
| | (Conventional | | | |
| Interfocal distance | shape) | 100 μm | 150 μm | 180 μm |
| Z tolerance range | 11 μm | 30 μm | 42 μm | 90 μm |

As shown in Table 1, in the case of the interfocal distance of 100 μm, the horizontal width in the above graph is 30 μm, which is at the boundary where the above specifications can be satisfied (see FIG. 4B). That is, the interfocal distance between the first focal point and the second focal point is preferably 100 μm or more.

FIG. 4C illustrates the relationships between the following: the distance between the first focal point and the second focal point (interfocal distance); the distance of the movement of light emitting element 122 in the direction along the Z axis; and the optical coupling efficiency between light emitting element 122 and optical transmission member 160.

Specifically, FIG. 4C shows the changes in the optical coupling efficiency when the distance between light emitting element 122 and first optical surface 141 is changed for the cases where the interfocal distances between the first focal point and the second focal point are as follows: 0 μm (prior art with one focal point), 100 μm (Z=100 μm), 150 μm (Z=150 μm), and 180 μm (Z=180 μm). In this graph, 0 dB is used as the optical coupling efficiency (that is, the amount of light emitted from light emitting element 122) when all the light emitted from light emitting element 122 is assumed to enter optical transmission member 160.

As for the specifications required for an optical receptacle, the optical coupling efficiency is preferably limited to −7 dB from the viewpoint of correct signal transmission. In FIG. 4C, the coupling efficiency is limited to −7 dB for all interfocal distances of 100 μm, 150 μm, and 180 μm, in the range where the movement amount is 30 μm (the curve is not symmetrical in the horizontal direction, but in the range of approximately +15 μm from the point of 0 μm), thus the above specifications can be satisfied. The case of an interfocal distance of 180 μm is located near the boundary where the above specifications can be satisfied. The above results are shown numerically in Table 2 below. As can be seen from FIG. 4C and Table 2, the interfocal distance between the first focal point and the second focal point is preferably 180 μm or less.

TABLE 2

| | 0 μm | | | |
|---|---|---|---|---|
| | (Conventional | | | |
| Interfocal distance | shape) | 100 μm | 150 μm | 180 μm |
| Maximum coupling | −5.0 | −2.4 | −3.4 | −6.1 |
| efficiency in movement | | | | |
| amount range of 30 μm (dB) | | | | |

### Effects

As described above, optical receptacle 140 according to Embodiment 1 has a wider Z tolerance range than a conventional optical receptacle. Therefore, optical module 100 according to the present embodiment is easy to assemble and resistant to temperature changes. For example, in optical module 100 according to the present embodiment, even when the focal point of first optical surface 141 is deviated in the direction along the Z axis due to, for example, the changes in volume or refractive index caused by the change in temperature, the coupling efficiency is less likely to change.

### Embodiment 2

### Configuration of Optical Module

Hereinafter, an optical module according to Embodiment 2 of the present invention will be described in detail with reference to the attached drawings.

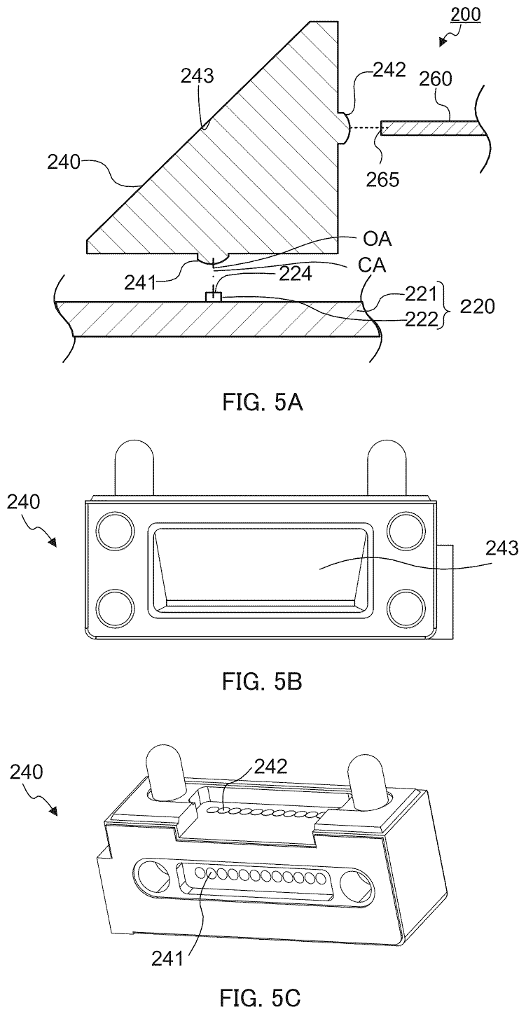

FIG. 5A schematically illustrates a cross section of optical module 200 according to Embodiment 2. FIG. 5B is a plan view of optical receptacle 240 according to Embodiment 2, and FIG. 5C is a perspective view of the optical receptacle from the bottom side.

As illustrated in FIG. 5A, optical module 200 includes optical receptacle 240 and substrate-mounted photoelectric conversion device 220 that includes light receiving elements 222. In the present embodiment, optical module 200 is an optical module for optical reception, and is used with optical receptacle 240 coupled (hereinafter also referred to as connected) with optical transmission member 260 via a ferrule.

The type of optical transmission member 260 is not limited. Examples of optical transmission member 160 include optical fibers and optical waveguides. In the present embodiment, optical transmission member 260 is an optical fiber. The optical fiber may be a single-mode optical fiber or a multi-mode optical fiber. The number of optical transmission members 260 is one or two or more. In the present embodiment, the number of optical transmission members 260 is two or more.

Photoelectric conversion device 220 includes substrate 221 and light receiving elements 222.

Substrate 221 supports light receiving elements 222. Substrate 221 is, for example, a glass composite substrate, a glass epoxy substrate, or a flexible substrate. Light receiving elements 222 are disposed on substrate 121.

Light receiving element 222 is disposed on substrate 221 and receives light from optical receptacle 240. The number of light receiving elements 222 is one or two or more. In the present embodiment, the number of light receiving elements 222 is two or more. Light receiving element 222 is disposed in such a way that light receiving surface 224 is positioned within the Z tolerance range of first optical surface 241 of optical receptacle 240.

Optical receptacle 240 is disposed on substrate 221 of photoelectric conversion device 220. Optical receptacle 240 optically couples end surface 225 of optical transmission member 260 with light receiving surface 224 of light receiving element 222 while being disposed between the photoelectric conversion device (light receiving element 222) and optical transmission member 260. The configuration of optical receptacle 240 will be described in detail separately.

Although the optical module is an optical module for reception in the above description, the optical module may be an optical module for transmission. In the case of an optical module for transmission, the photoelectric conversion element is a light emitting element, and light emitted from the light emitting element enters optical transmission member 160.

### Configuration of Optical Receptacle

Optical receptacle 240 allows light to pass therethrough and includes first optical surfaces 241 and second optical surfaces 242. Second optical surface 242 allows light emitted from end surface 265 of optical transmission member 260 to enter optical receptacle 240. First optical surface 241 emits the light having entered through second optical surface 242 toward light receiving surface 224 of light receiving element 222. In the present embodiment, the number of second optical surfaces 242 is two or more and the number of first optical surfaces 241 is also two or more. Optical receptacle 240 according to the present embodiment includes reflecting surface 243 in addition to the above configuration.

Optical receptacle 240 is formed of a material that allows light having a wavelength used for optical communication to pass therethrough. Examples of such materials include transparent resins such as polyetherimide (PEI) and cyclic olefin resins. Moreover, optical receptacle 240 is produced by, for example, injection molding.

Second optical surface 242 is an optical surface that refracts light emitted from optical transmission member 260 to enter optical receptacle 240. Second optical surface 242 can convert the light emitted from optical transmission member 260 into collimated light, converged light, or diffused light. In the present embodiment, second optical surface 242 converts the light emitted from optical transmission member 260 so as to narrow the light flux of the light, converging the light into collimated light. The narrowed light flux travels toward first optical surface 241 after being totally reflected by reflecting surface 243, as will be described below. In the present embodiment, second optical surface 242 has a shape of a convex lens surface that is convex toward optical transmission member 260. In addition, the shape of second optical surface 242 in plan view is circular.

Reflecting surface 243 is an inclined surface formed on the top surface side of optical receptacle 240 and disposed on the optical path between second optical surface 242 and first optical surface 241. Reflecting surface 243 reflects light incident on second optical surface 242 (light emitted from optical transmission member 260) toward first optical surface 241. Reflecting surface 243 may be a flat surface or curved surface. In the present embodiment, reflecting surface 243 is a flat surface. Reflecting surface 243 is inclined so as to approach optical transmission member 260 from the bottom surface of optical receptacle 240 toward the top surface of the optical receptacle. In the present embodiment, the inclination angle of reflecting surface 243 is 45° with respect to the optical axis of light incident on second optical surface 242. In the optical receptacle, light incident on second optical surface 242 is incident on reflecting surface 243 at an incident angle larger than the critical angle. Thereby, reflecting surface 243 totally reflects the incident light in such a way that the light becomes perpendicular to the surface of substrate 221.

First optical surface 241 is an optical surface that emits light reflected by reflecting surface 243 toward light receiving surface 224 of light receiving element 222. In the present embodiment, first optical surface 241 is disposed on the bottom surface of optical receptacle 240 so as to face light receiving surface 224 of light receiving element 222. First optical surface 241 has a shape of a convex lens surface that is convex toward light receiving surface 224 of light receiving element 222. In the present embodiment, central axis CA of first optical surface 241 coincides with optical axis OA of light receiving surface 224 of light receiving element 222. As a result, the light that is incident on second optical surface 242 and reflected by reflecting surface 243 can be collected and efficiently incident on light receiving surface 224 of light receiving element 222.

First optical surface 241 in optical receptacle 240 according to Embodiment 2 also has the same characteristics as first optical surface 141 in optical receptacle 140 according to Embodiment 1. That is, as illustrated in FIG. 3, a first focal point observed when viewed along a direction of the X axis and a second focal point observed when viewed along a direction of the Y axis are formed, and the second focal point is observed closer to first optical surface 241 than the first focal point is. In the present embodiment, the definition of the XYZ coordinate system is the same as in Embodiment 1. As in Embodiment 1, first optical surface 241 is a convex lens surface in which the curvature on the XZ plane passing through the origin is greater than the curvature on the YZ plane passing through the origin. The first focal point is formed due to the curvature of first optical surface 241 along the Y-axis direction, and the second focal point is formed due to the curvature of first optical surface 241 along the X-axis direction. That is, first optical surface 241 is configured in such a way that when collimated light from the inside of optical receptacle 240 is incident on first optical surface 241, a first focal point observed when viewed along a direction of the X axis and a second focal point observed when viewed along a direction of the Y axis are formed, and the second focal point is observed closer to first optical surface 241 than the first focal point is. By configuring first optical surface 241 in this manner, the depth of focus of first optical surface 241 can be increased and the Z tolerance range can be widened.

In the present embodiment, first optical surface 241 is symmetrical with respect to the XZ plane and also symmetrical with respect to the YZ plane. Therefore, first optical surface 241 is not circularly symmetrical, but is two-fold symmetrical.

Although the example in which first optical surface 241 is a convex lens surface has been described above, first optical surface 241 is not limited thereto. First optical surface 241 may have any configuration as long as the first optical surface can form a first focal point and a second focal point, and may be, for example, a diffractive lens.

In the present embodiment, the distance between the first focal point and the second focal point is preferably more than 0 μm and 100 μm or less, more preferably more than 0 μm and 80 μm or less, and even more preferably more than 0 μm and 50 μm or less, from the viewpoints of optical coupling efficiency and correct signal transmission. Details of this will be described below.

Light emitted from optical transmission member 260 enters optical receptacle 240 through second optical surface 242. The light having entered optical receptacle 240 is internally reflected by reflecting surface 243 and travels toward first optical surface 241. The light having reached first optical surface 241 is emitted so as to converge toward light receiving surface 224 of first optical surface 241.

Although the optical receptacle is an optical receptacle for reception in the above description, the optical receptacle may be an optical receptacle for transmission. In the case of an optical receptacle for transmission, first optical surface 241 allows light from a light emitting element to enter the optical receptacle, and second optical surface 141 emits the light toward optical transmission member 260. In addition, reflecting surface 243 reflects the light incident on first optical surface 241 (the light emitted from light emitting element) toward second optical surface 242.

### Simulation

Hereinafter, in optical module 200 according to Embodiment 2, the relationships between the following will be described: the interfocal distance between the first focal point and the second focal point; the positional deviation of light receiving element 222 in the direction along the Z axis; and the optical coupling efficiency between optical transmission member 260 and light receiving element 222.

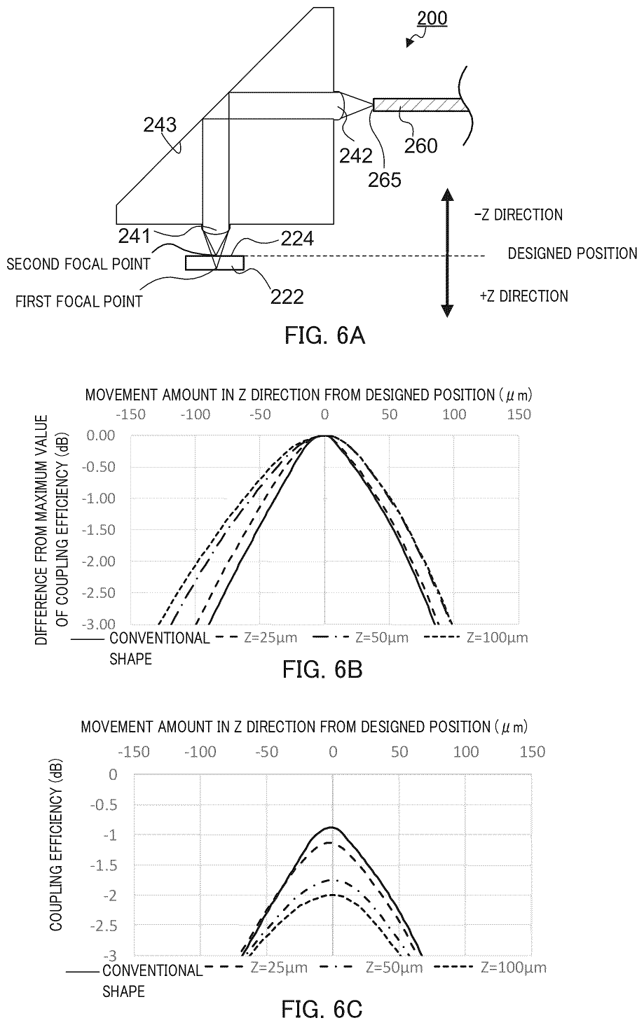

FIG. 6A schematically illustrates a state when light is emitted from optical transmission member 260, is incident on second optical surface 242, is emitted from first optical surface 241, and reaches light receiving element 222. It should be noted that FIG. 6A is for illustration purposes and is not drawn to scale.

FIG. 6B illustrates the relationships between the following: the distance between the first focal point and the second focal point (interfocal distance); the movement amount of light receiving element 222 from a designed position; and the change in the optical coupling efficiency between optical transmission member 260 and light receiving element 222. As illustrated in FIG. 6A, the movement amount from the designed position was given a negative value when the distance between light receiving element 222 and first optical surface 241 decreases, and a positive value when the distance increases.

FIG. 6B is a graph showing the changes in the optical coupling efficiency when the distance between light receiving element 222 and first optical surface 241 is changed as illustrated in FIG. 6A for the cases where the interfocal distances between the first focal point and the second focal point are as follows: 0 μm (prior art), 100 μm, 150 μm, and 180 μm. In this graph, 0 dB is used as the optical coupling efficiency at the maximum value for each interfocal distance. In addition, the distance along the optical path from second optical surface 242 to light receiving surface 224 of light receiving element 222 is set to 0.35 mm at the designed position.

As can be seen from FIG. 6B, the shorter the interfocal distance is, the more vulnerable to the change in the distance between light receiving element 222 and first optical surface 241. The change in the distance between light receiving element 222 and first optical surface 241 increases the difference from the maximum value of the coupling efficiency. That is, the shorter the interfocal distance, the narrower the Z tolerance range.

FIG. 6C illustrates the relationships between the following: the distance between the first focal point and the second focal point (interfocal distance); the distance of the movement of light receiving element 222 in the direction along the Z axis; and the optical coupling efficiency between light receiving element 222 and optical transmission member 260.

Specifically, FIG. 6C shows the changes in the optical coupling efficiency when the distance between light receiving element 222 and first optical surface 241 is changed for the cases where the interfocal distances between the first focal point and the second focal point are as follows: 0 μm (prior art with one focal point), 25 μm (Z=25 μm), and 100 μm (Z=100 μm). In this graph, 0 dB is used as the optical coupling efficiency (that is, the amount of light emitted from optical transmission member 260) when all the light emitted from optical transmission member 260 is assumed to enter light receiving element 222.

As for the specifications required for an optical receptacle, in the range of movement amount of 30 μm, the optical coupling efficiency is preferably limited to −2 dB from the viewpoint of correct signal transmission. In FIG. 6C, at the point where the movement amount is 0 μm, the coupling efficiency is limited to −2 dB for all interfocal distances of 25 μm, 50 μm, and 100 μm. At this point, the above specifications thus can be satisfied. The case of an interfocal distance of 100 μm is located near the boundary where the above specifications can be satisfied. The above results are shown numerically in Table 3 below. As can be seen from FIG. 6C and Table 3, the interfocal distance between the first focal point and the second focal point is preferably more than 0 μm and 100 μm or less, more preferably more than 0 μm and 80 μm or less, and even more preferably more than 0 μm and 50 μm or less.

TABLE 3

| | 0 μm | | | |
|---|---|---|---|---|
| | (Conventional | | | |
| Interfocal distance | shape) | 25 μm | 50 μm | 100 μm |
| Maximum coupling efficiency | −0.9 | −1.1 | −1.8 | −2.0 |
| in movement amount range of | | | | |
| 30 μm (dB) | | | | |

### Effects

As described above, optical receptacle 240 according to Embodiment 2 has a wider Z tolerance range than a conventional optical receptacle. Therefore, optical module 200 according to the present embodiment is easy to assemble and resistant to temperature changes. For example, in optical module 200 according to the present embodiment, even when the position of optical receptacle 240 is deviated in the direction along the Z axis during assembly of optical module 200, the coupling efficiency is less likely to change.

### INDUSTRIAL APPLICABILITY

The optical receptacles and optical modules according to the present invention are particularly advantageous for optical communication using, for example, an optical transmission member.

### REFERENCE SIGNS LIST

100, 200 Optical module
120, 220 Photoelectric conversion device
121, 221 Substrate
122 Light emitting element
123 Light emitting surface
125 End surface
140, 240 Optical receptacle
141 241 First optical surface
243 Reflecting surface
142, 242 Second optical surface
144 Positioning portion
145 Substrate fixing portion
146 First recess
160, 260 Optical transmission member
222 Light receiving element
224 Light receiving surface

1. An optical receptacle configured to be disposed between a photoelectric conversion element and an optical transmission member, the optical receptacle being configured to optically couple the photoelectric conversion element with an end surface of the optical transmission member, the optical receptacle comprising:
a first optical surface configured to allow light emitted from the photoelectric conversion element to be incident thereon, or configured to emit, toward the photoelectric conversion element, light emitted from the end surface of the optical transmission member and traveling inside the optical receptacle; and
a second optical surface configured to emit the light incident on the first optical surface toward the end surface of the optical transmission member, or configured to allow the light emitted from the end surface of the optical transmission member to be incident thereon,
wherein
when an origin is defined as an intersection point between the first optical surface and an optical axis of the first optical surface, a Z axis is defined as the optical axis of the first optical surface, an X axis is defined as an axis passing through the origin and perpendicular to the Z axis, and a Y axis is defined as an axis perpendicular to the Z axis and the X axis,
the first optical surface is configured in such a way that when collimated light from an inside of the optical receptacle is incident on the first optical surface, a first focal point observed when viewed along a direction of the X axis and a second focal point observed when viewed along a direction of the Y axis are formed, the second focal point being observed closer to the first optical surface than the first focal point is.

2. The optical receptacle according to claim 1, wherein the first optical surface is a convex lens surface in which a curvature on an XZ plane passing through the origin is greater than a curvature on a YZ plane passing through the origin.

3. The optical receptacle according to claim 1, wherein a distance between the first focal point and the second focal point is 100 μm or more and 180 μm or less.

4. The optical receptacle according to claim 1, further comprising:
a reflecting surface disposed between the first optical surface and the second optical surface, wherein
a distance between the first focal point and the second focal point is more than 0 μm and 100 μm or less.

5. An optical module comprising:
a photoelectric conversion element; and
the optical receptacle according to claim 1.
